(19) United States
(12) Patent Application Publication
(10) Pub. No.: US 2009/0144657 A1
(43) Pub. Date: Jun. 4, 2009

(54) METHOD AND SYSTEM OF SHARING IMAGES CAPTURED BY A MOBILE COMMUNICATION DEVICE

(75) Inventors: Xi Zhang, Newton, MA (US); Albert L. Schmidt, Hopkinton, MA (US); Stephen D. Morrison, Watertown, MA (US); Christopher M. Martin, Walpole, MA (US)

Correspondence Address: VERIZON;PATENT MANAGEMENT GROUP, 1320 North Court House Road, 9th Floor, ARLINGTON, VA, 22201-2909, US

(73) Assignee: Verizon Laboratories Inc., Waltham, MA (US)

(21) Appl. No.: 11/947,917

(22) Filed: Nov. 30, 2007

(51) Int. Cl. G06F 3/048; G06F 15/16

(52) U.S. Cl. 715/810; 709/204

(57) ABSTRACT

An approach is disclosed for sharing images using a mobile device. An image is captured by the mobile device, which can establish a voice call over a wireless network. A menu of options is presented to a user for sharing the image with other users, wherein one of the options includes uploading the image to a remote platform configured to store the image in a folder among a plurality of folders. A text message is generated, in response to selection of the one option, according to a messaging protocol for transmitting the image over the wireless network to a gateway coupled to the remote platform. The text message includes information specifying one of the folders for storing the image. At least one of the folders is identified to indicate how the image is to be shared.

### BACKGROUND INFORMATION

Wireless communication technologies afford users with the convenience of mobility and continually expanding set of capabilities. This convenience has spawned significant adoption by an ever growing number of subscribers as an accepted mode of communication for business and personal uses in terms of communicating using voice and data services. As wireless communication devices become more sophisticated, their features have expanded from merely placing and receiving calls to other enhanced services from music downloads to digital photography. Photo or image sharing has shown dramatic growth, as evidence by the prevalence of camera enabled phones. From the user's perspective, taking a photo on a mobile phone is quite easy and intuitive, but sharing and managing photos is rather onerous. Conventionally, users are severely restricted on how photos are uploaded and exchanged.

Therefore, there is a need for an approach that provides enhanced image sharing and management services.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of sharing images using mobile communication devices, according with an exemplary embodiment;

FIGS. 2A and 2B are flowcharts of processes for sharing images, according to an exemplary embodiment;

FIG. 3 is a flowchart of a process for setting up a user profile to participate in an image sharing and management service, according to an exemplary embodiment;

FIG. 4 is a diagram of a mobile communication device utilizing a user interface for sharing images, according to an exemplary embodiment; and

FIG. 5 is a diagram of a computer system that can be used to implement various exemplary embodiments.

### DETAILED DESCRIPTION OF THE PREFERRED EMBODIMENTS

An apparatus, method, and software for providing image sharing are described. In the following description, for the purposes of explanation, numerous specific details are set forth in order to provide a thorough understanding of the various exemplary embodiments. It is apparent, however, to one skilled in the art that the various exemplary embodiments may be practiced without these specific details or with an equivalent arrangement. In other instances, well-known structures and devices are shown in block diagram form in order to avoid unnecessarily obscuring the exemplary embodiments.

Although the various embodiments are described with respect to Multimedia Messaging Service (MMS) and Short Message Service (SMS) protocols, it is contemplated that these embodiments have applicability to other equivalent protocols.

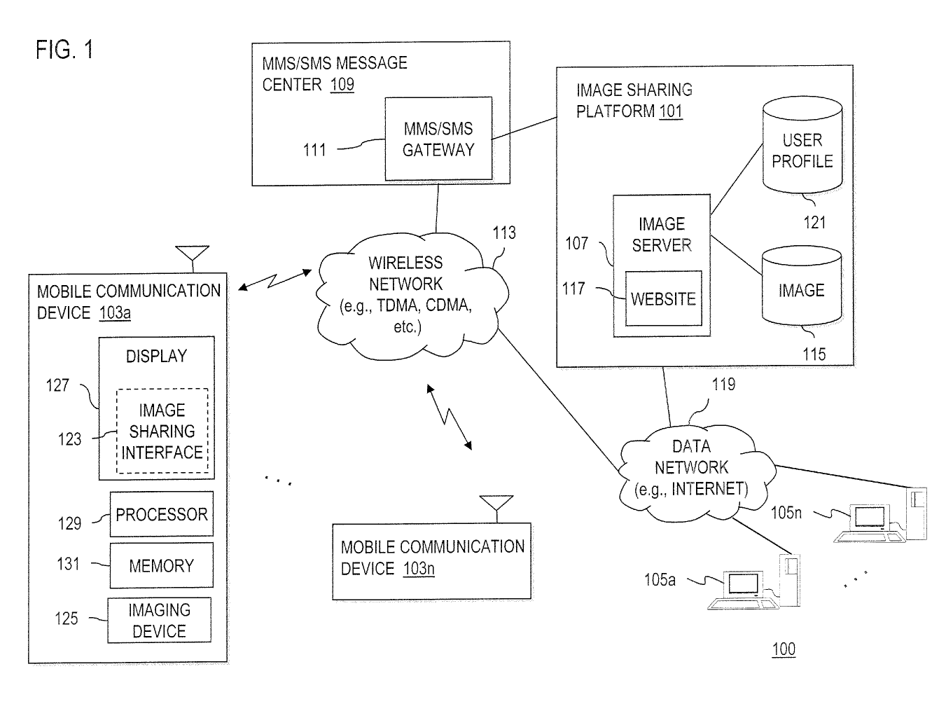

FIG. 1 is a diagram of a system capable of sharing images using mobile communication devices, according with an exemplary embodiment. A communication system 100 includes a content sharing platform 101 for enabling users to efficiently and intuitively share content. That is, the users can share or otherwise exchange content (e.g., images) among users of mobile communication devices 103a-103n as well as users of computing devices 105a-105n. For the purposes of illustration, the content sharing platform 101 provides the sharing of “images,” and thus, is denoted as an “image sharing platform.” As used herein, “images” refer to digital photos as well as video clips. However, it is contemplated that the remote platform 101 (i.e., remote from the devices 103a-103n) can be configured to share content in general, such content can include either text, image, audio, video, or any combination thereof.

Under this scenario, the platform 101 includes a content (e.g., image) module or server 107 that communicates with, according to one embodiment, a MMS (Multimedia Messaging Service) and SMS (Short Message Service) message center 109 via a MMS/SMS gateway 111 to permit sharing of content among the group of mobile communication devices 103a-103n with users. MMS utilizes both Wireless Application Protocol (WAP) and SMS technologies to transfer multimedia communications. SMS service enables the transmission of short text messages among the devices 103a-103n in a store and forward manner. These short text messages in general can be delivered at any point in time using out-of-band packet, low-bandwidth delivery mechanisms. Similarly, MMS is a store and forward mechanism that supports transfer of media. MMS defines the exchange of wireless messages that include images, audio, and video clips as well as text. Such content is uploaded from one or more of the mobile communication devices 103a-103n to the content server 107 via a wireless network 113, and is stored in an image database 115.

The wireless network 113 can employ various technologies, including Time Division Multiple Access (TMDA), Code Division Multiple Access (CDMA), etc.

As shown, the image server 107 can also behave as a website 117 to permit access of the stored images by the computing devices 105a-105n over a data network 119. The computing devices 105a-105n can be a personal computer (PC), laptop, palm computer, workstation, web appliance, etc. The devices 105a-105n communicate with a website 117 over a data network 119 (which can include the global Internet). Under this arrangement, images to be shared among the devices 105a-105n can be viewed via a web browser or other web-based application. The server 107 communicates with a user profile database 121, which maintains user preferences and parameters relating to the storing and distribution of the images. If multiple services are offered for photo sharing, the user can specify the particular service to use in the user profile.

In an exemplary embodiment, each of the mobile communication devices 103a-103n includes an image sharing interface 123, which provides soft controls for sharing images captured by an imaging device 125. The “soft keys” can be presented to the user via a display 127. In addition to a graphical user interface (GUI) implementation, the image sharing interface 123 can be combined and/or exclusively be deployed with physical controls, such as a keypad, touch pad, etc. The wireless devices 103a-103n also includes a processor 129 and a memory 131 configured to store and execute instructions for supporting the imaging sharing and management service, as well as other communication functions.

Conventional systems, such as native MMS protocol or rich MMS/SMS schemes, address only one aspect of the photo sharing management experience, namely, the uploading activity. It is further recognized that these systems do not provide a satisfactory approach for users to easily share the photos and manage their photo account on the mobile phones. Thus, these systems need to rely heavily on other mechanisms, such as the web, to perform sharing and management.

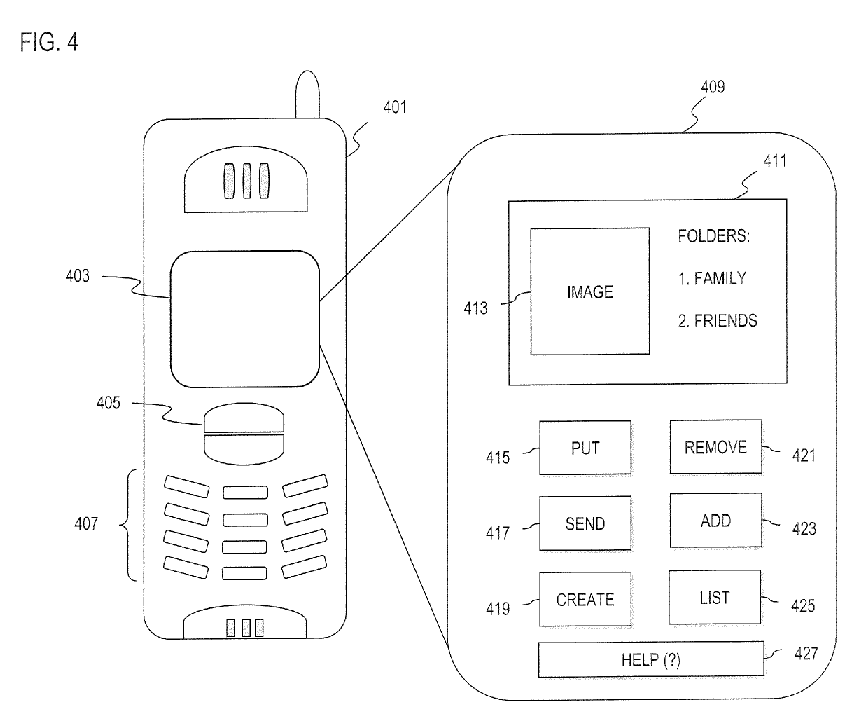

By contrast, the approach of FIG. 1, according to certain embodiments, provides for interacting with the MMS/SMS gateway 111 with a predefined and easy-to-use command set that is tailored for photo sharing. As more detailed in FIG. 4, this approach allows users to quickly complete the actions needed for a successful photo sharing experience, from uploading photos (e.g., to certain folders) to sending out invitations.

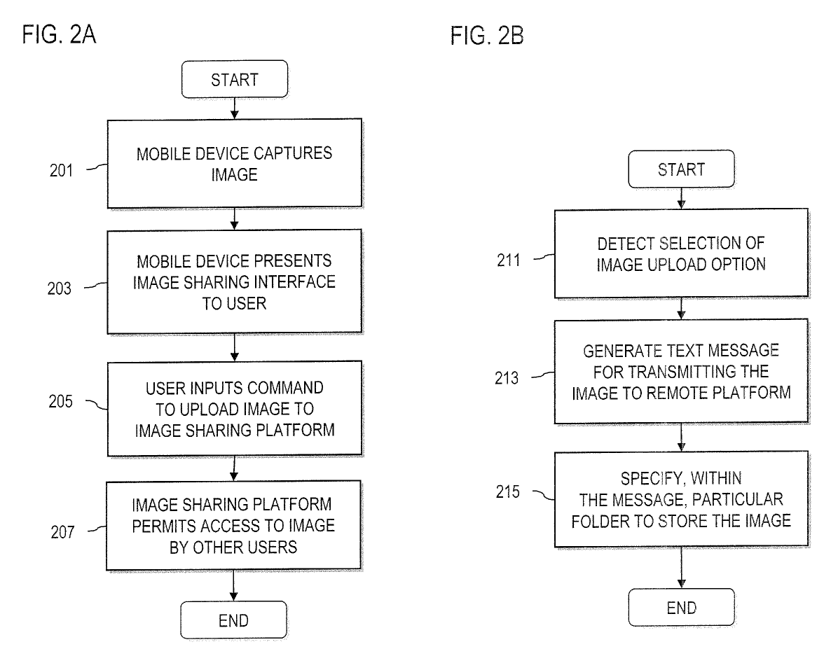

FIGS. 2A and 2B are flowcharts of processes for sharing images, according to an exemplary embodiment. By way of example, a user of a mobile device 103a captures an image through the imaging device (i.e., camera) 125, per step 201. In step 203, the device 103a presents an image sharing interface 123 to the user—in one embodiment, a graphical user interface (GUI) shown in FIG. 4 can be used. The user can then input a command for uploading the image, as in step 205, to the image server 107. The image sharing interface 123 can provide an MMS interface, whereby the user types in an address, which can be any identifier, in the “To” field (assuming the identifier has been pre-confirmed) and specify a name of the folder that should store image within the “Body” field. Once the user initiates the transmission of the image, for example, by depressing a “Send” button, the attached photos are uploaded to the specified folder on the image server 107. In this manner, the image can be accessed by any user associated with the folder (step 207). For example, if the user specifies a “family folder,” then only family members can access the images stored in this folder. According to one embodiment, a default folder can be designated. Further, uploading to a temporary folder can result in sending the image to a contact list that is created by the user.

This above approach creates a simplified photo sharing/management experience by simplifying addressing and introducing a simple photosharing/management command language to use in the text message header and body. As shown in FIG. 2B, the device 103a detects selection of an image upload option, per step 211. Next, a text message is generated for transmitting the image to the remote platform 101 (step 213). Specified within this message is the particular folder (of the server 107) that the user has chosen to store the image (step 215). This command language can be on top of the MMS/SMS protocol (which typically does not support a rich photo sharing capability). By interacting with the MMS/SMS gateway 111 that is connected with the remote server 107, users, via the mobile devices 103a-103n, can readily upload images or photos to a website 117 or share the image with his/her social network immediately by using the mobile device 103a, for instance. A companion website 117 with personalized information can be created for users to satisfy their additional, richer sharing requirements.

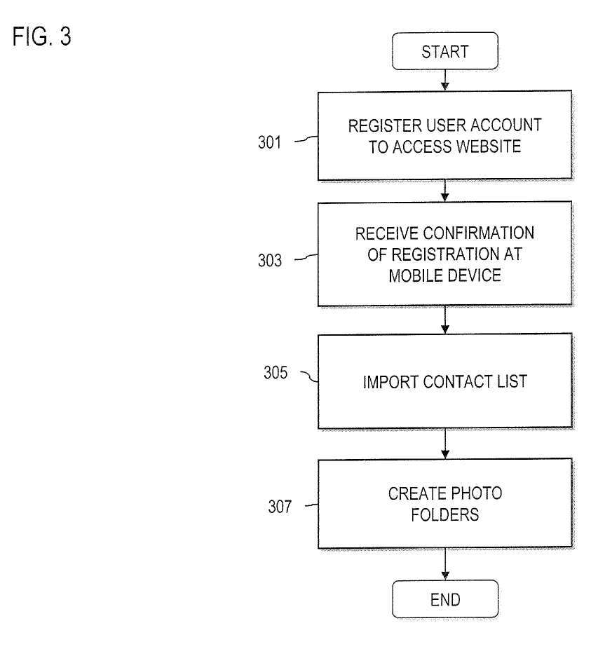

FIG. 3 is a flowchart of a process for setting up a user profile to participate in an image sharing and management service, according to an exemplary embodiment. As explained, the image sharing platform 101 provides a rich set of image sharing capabilities through the website 117. That is, the website 117 is used to host users profile information and store uploaded photo and contact information. According to one embodiment, the user is provided with a personalized space within the website 117. The personalized space can be accessed by a web browser within a computing device, e.g., device 105a. This space can be assigned a Uniform Resource Locator (URL) that indicates, for instance, either a cell phone number or user ID, for example, “www.scriptingshare.com/myusername” or “www.scriptingshare.com/6178751234.”

To avail themselves of the photo sharing capabilities, users perform a procedure to set-up their user profiles, as next explained. In step 301, a user account is registered on the website 117, which can then send a confirmation to the user's mobile device 103a (step 303). Also, the server 107 can transmit a message providing a confirmation code to the mobile device 103a, and the user can in turn get confirmed by replying to the message.

In step 305, the user can optionally complete the registration process by importing existing grouped contact list from a variety of sources, e.g., email client. As another option, the user can also create photo storage folders, per step 307. These optional steps can be performed via the image sharing interface 123.

FIG. 4 is a diagram of a mobile communication device utilizing a user interface for sharing images, according to an exemplary embodiment. By way of example, the mobile device 103a of FIG. 1 can be implemented as a mobile phone 401, which includes a display 403 that is configured to present content an GUI, such as the image sharing interface 123 (of FIG. 1). In one embodiment, the user of the mobile phone 401 can input information, via cursor buttons 405 or key pad 407. Further, these cursor buttons 405 or keys of the key pad 407 can control a camera function or an audio recording function.

As previously explained, upon taking a photo, the user interacts with the MMS/SMS gateway 111 using the image sharing interface 123 to create a text message, which takes advantage of an SMS short code (e.g., 88111) to simplify addressing, and then uses a predefined command set to communicate with the image sharing platform 101. As shown, screen 409 includes an area 411 that includes a section 413 for the subject image. In an exemplary embodiment, the area 411 can enumerate the folders that are available to the user: (1) “family”; and (2) “friends.” Soft keys or buttons 415-421 are provide to correspond to the command set. Exemplary commands are listed in Table 1, below:

TABLE 1

| COMMAND | DESCRIPTION |
|---|---|
| PUT 415 | Upload selected photo(s) to default folder (specified via |
| | web interface or via SMS) or specified folder on the |
| | remote server 107 (e.g., PUT “family” folder). This |
| | command can extend to uploading photo to a user's |
| | preferred social networking site, for example. |
| SEND 417 | Upload selected photo(s) to a temporary folder on the |
| | remote server 107 and send invitation to default contact |
| | list or a specified contact group, e.g., “SEND |
| | class_mate_2001.” |
| CREATE 419 | Create a new folder with specified name. |
| REMOVE 421 | Remove a folder with specified name. |
| ADD 423 | Add new contact info (email or cell phone number) to a |
| | specified contact group, e.g., ADD joe@gmail.com |
| | class_mate_2001. |
| LIST 425 | Global command to list all photos in different folder |
| HELP (?) 427 | Global command for how to use certain commands - e.g., |
| | PUT? will return a text message from the server 107 on |
| | how to use the PUT command. |

The commands listed above are illustrative of the type of commands that can be invoked to share images. According to one embodiment, the above commands can be used with an address book (which could be synchronized with a server). The address book can be enhanced to contain types such as a “website”, “folder” and “groups”. Accordingly, after the user takes a photo or records a video, the user can select a command from a list from soft key button or enter a command in message body, such as “PUT” or “SEND,” and then press an “address book” option and select the destination of the image or video from a list. These commands provide a convenient interface for users to exchange and disseminate images.

The above described processes relating to providing image (e.g., photo) sharing may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

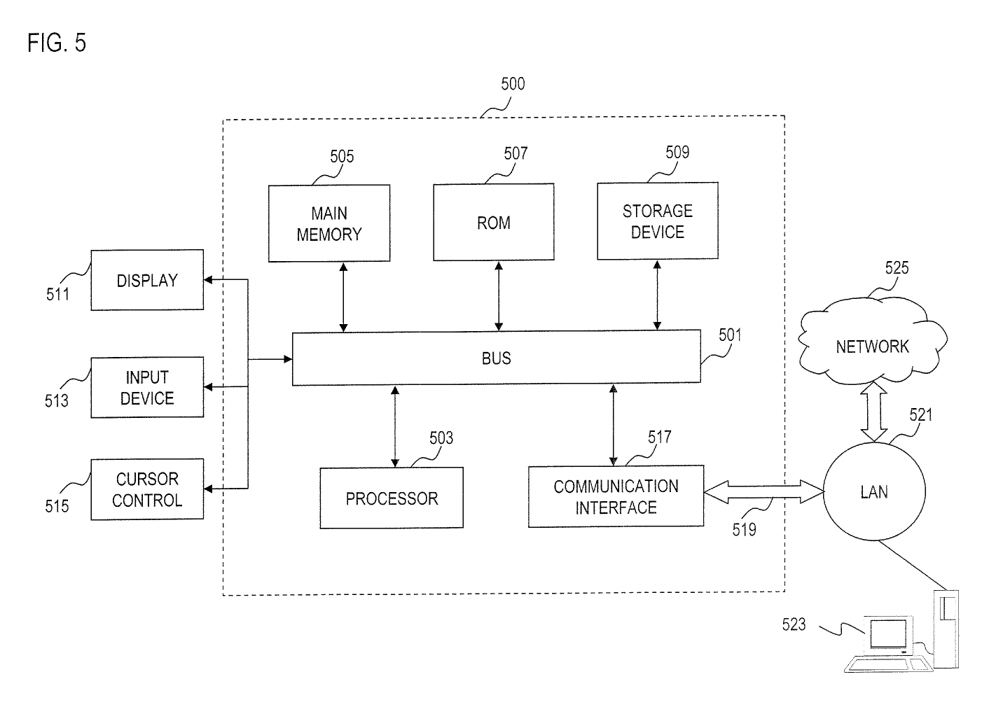

FIG. 5 illustrates a computer system 500 upon which an exemplary embodiment can be implemented. For example, the processes described herein can be implemented using the computer system 500. The computer system 500 includes a bus 501 or other communication mechanism for communicating information and a processor 503 coupled to the bus 501 for processing information. The computer system 500 also includes main memory 505, such as a random access memory (RAM) or other dynamic storage device, coupled to the bus 501 for storing information and instructions to be executed by the processor 503. Main memory 505 can also be used for storing temporary variables or other intermediate information during execution of instructions by the processor 503. The computer system 500 may further include a read only memory (ROM) 507 or other static storage device coupled to the bus 501 for storing static information and instructions for the processor 503. A storage device 509, such as a magnetic disk or optical disk, is coupled to the bus 501 for persistently storing information and instructions.

The computer system 500 may be coupled via the bus 501 to a display 511, such as a cathode ray tube (CRT), liquid crystal display, active matrix display, or plasma display, for displaying information to a computer user. An input device 513, such as a keyboard including alphanumeric and other keys, is coupled to the bus 501 for communicating information and command selections to the processor 503. Another type of user input device is a cursor control 515, such as a mouse, a trackball, or cursor direction keys, for communicating direction information and command selections to the processor 503 and for controlling cursor movement on the display 511.

According to an embodiment, the processes described herein are performed by the computer system 500, in response to the processor 503 executing an arrangement of instructions contained in main memory 505. Such instructions can be read into main memory 505 from another computer-readable medium, such as the storage device 509. Execution of the arrangement of instructions contained in main memory 505 causes the processor 503 to perform the process steps described herein. One or more processors in a multi-processing arrangement may also be employed to execute the instructions contained in main memory 505. In alternative embodiments, hard-wired circuitry may be used in place of or in combination with software instructions to implement the exemplary embodiment. Thus, exemplary embodiments are not limited to any specific combination of hardware circuitry and software,

The computer system 500 also includes a communication interface 517 coupled to bus 501. The communication interface 517 provides a two-way data communication coupling to a network link 519 connected to a local network 521. For example, the communication interface 517 may be a digital subscriber line (DSL) card or modem, an integrated services digital network (ISDN) card, a cable modem, a telephone modem, or any other communication interface to provide a data communication connection to a corresponding type of communication line. As another example, communication interface 517 may be a local area network (LAN) card (e.g. for Ethernet™ or an Asynchronous Transfer Model (ATM) network) to provide a data communication connection to a compatible LAN. Wireless links can also be implemented. In any such implementation, communication interface 517 sends and receives electrical, electromagnetic, or optical signals that carry digital data streams representing various types of information. Further, the communication interface 517 can include peripheral interface devices, such as a Universal Serial Bus (USB) interface, a PCMCIA (Personal Computer Memory Card International Association) interface, etc. Although a single communication interface 517 is depicted in FIG. 5, multiple communication interfaces can also be employed.

The network link 519 typically provides data communication through one or more networks to other data devices. For example, the network link 519 may provide a connection through local network 521 to a host computer 523, which has connectivity to a network 525 (e.g. a wide area network (WAN) or the global packet data communication network now commonly referred to as the “Internet”) or to data equipment operated by a service provider. The local network 521 and the network 525 both use electrical, electromagnetic, or optical signals to convey information and instructions. The signals through the various networks and the signals on the network link 519 and through the communication interface 517, which communicate digital data with the computer system 500, are exemplary forms of carrier waves bearing the information and instructions.

The computer system 500 can send messages and receive data, including program code, through the network(s), the network link 519, and the communication interface 517. In the Internet example, a server (not shown) might transmit requested code belonging to an application program for implementing an exemplary embodiment through the network 525, the local network 521 and the communication interface 517. The processor 503 may execute the transmitted code while being received and/or store the code in the storage device 509, or other non-volatile storage for later execution. In this manner, the computer system 500 may obtain application code in the form of a carrier wave.

The term “computer-readable medium” as used herein refers to any medium that participates in providing instructions to the processor 503 for execution. Such a medium may take many forms, including but not limited to non-volatile media, volatile media, and transmission media. Non-volatile media include, for example, optical or magnetic disks, such as the storage device 509. Volatile media include dynamic memory, such as main memory 505. Transmission media include coaxial cables, copper wire and fiber optics, including the wires that comprise the bus 501. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the various exemplary embodiments may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that flow. The specification and the drawings are accordingly to be regarded in an illustrative rather than restrictive sense.

What is claimed is:

1. A method comprising:
capturing an image by a mobile device configured to establish a voice call over a wireless network;
presenting a menu of options to a user for sharing the image with other users, wherein one of the options includes uploading the image to a remote platform configured to store the image in a folder among a plurality of folders; and
generating, in response to selection of the one option, a text message according to a messaging protocol for transmitting the image over the wireless network to a gateway coupled to the remote platform, wherein the text message includes information specifying one of the folders for storing the image, at least one of the folders being identified to indicate how the image is to be shared.

2. A method according to claim 1, wherein the options include uploading to a default folder; uploading to a temporary folder and sending the image to a contact list; creating a new folder; removing one or more of the folders; adding contact information to the contact list; or moving the image to a different folder.

3. A method according to claim 2, wherein the options further include a help function to inform the user about the options.

4. A method according to claim 2, wherein the contact list is imported from an application external from the mobile device.

5. A method according to claim 1, wherein the platform includes a database configured to store a profile of the user, the profile including information relating to selection by the user of one of a plurality of image sharing services.

6. A method according to claim 1, wherein the messaging protocol includes a Multimedia Messaging Service (MMS) protocol.

7. A method according to claim 1, wherein the platform includes a web server configured to permit access to the image via a data network according to the folder in which the image is stored.

8. A method according to claim 1, wherein the mobile device is a cellular phone.

9. An apparatus comprising:
circuitry configured to establish a voice call over a wireless network;
an imaging device configured to capture an image;
a user interface configured to present a menu of options to a user for sharing the image with other users, wherein one of the options includes uploading the image to a remote platform configured to store the image in a folder among a plurality of folders; and
a processor configured to generate, in response to selection of the one option, a text message according to a messaging protocol for transmitting the image over the wireless network to a gateway coupled to the remote platform, wherein the text message includes information specifying one of the folders for storing the image, the folders being identified to indicate how the image is to be shared.

10. An apparatus according to claim 9, wherein the options include uploading to a default folder; uploading to a temporary folder and sending the image to a contact list; creating a new folder; removing one or more of the folders; adding contact information to the contact list; or moving the image to a different folder.

11. An apparatus according to claim 10, wherein the options further include a help function to inform the user about the options.

12. An apparatus according to claim 10, wherein the contact list is imported from an application external from the mobile device.

13. An apparatus according to claim 9, wherein the platform includes a database configured to store a profile of the user, the profile including information relating to selection by the user of one of a plurality of image sharing services.

14. An apparatus according to claim 9, wherein the messaging protocol includes a Multimedia Messaging Service (MMS) protocol.

15. An apparatus according to claim 9, wherein the platform includes a web server configured to permit access to the image via a data network according to the folder in which the image is stored.

16. A system comprising:
a gateway configured to receive an image over a wireless network from a mobile device, wherein the mobile device is configured to capture the image and to establish a voice call over the wireless network, the mobile device including a user interface configured to present a menu of options to a user for sharing the image with other users; and
a platform coupled to the gateway and configured to store the image in a folder among a plurality of folders, the platform being situated remotely from the mobile device, one of the options including uploading the image to the platform,
wherein the mobile device is further configured to generate a text message according to a messaging protocol, in response to selection of the one option, for transmitting the image over the wireless network to the gateway, the text message including information specifying one of the folders for storing the image, at least one of the folders corresponding to a type of users or devices that are permitted access to the image.

17. A system according to claim 16, wherein the options include uploading to a default folder; uploading to a temporary folder and sending the image to a contact list; creating a new folder; removing one or more of the folders; adding contact information to the contact list; and moving the image to a different folder.

18. A system according to claim 17, wherein the options further include a help function to instruct the user about the options.

19. A system according to claim 17, wherein the contact list is imported from an application external from the mobile device.

20. A system according to claim 16, wherein the messaging protocol includes a Multimedia Messaging Service (MMS) protocol.

21. A system according to claim 16, wherein the platform includes a web server configured to permit access to the image via a data network according to the folder in which the image is stored.
